(19) United States
(12) Patent Application Publication
(10) Pub. No.: US 2016/0314425 A1
(43) Pub. Date: Oct. 27, 2016

(54) CROWD SOURCING REAL ESTATE VALUATION ESTIMATES

(71) Applicant: HomeAhead LLC, Bellaire, TX (US)

(72) Inventors: David Cunningham, Bellaire, TX (US); Taylor Hou, Bellaire, TX (US); Lu Zhang, Bellaire, TX (US)

(21) Appl. No.: 15/139,864

(22) Filed: Apr. 27, 2016

Related U.S. Application Data
(60) Provisional application No. 62/153,428, filed on Apr. 27, 2015.
(60) Provisional application No. 62/169,284, filed on Jun. 1, 2015.

(51) Int. Cl. G06Q 10/06; G06Q 30/02; G06F 17/30

(52) U.S. Cl. CPC G06Q 10/06398; G06F 17/3053; G06Q 30/0281; G06Q 30/0278; G06Q 50/16

(57) ABSTRACT

Provided is process including obtaining a plurality of estimates for a value of a real property from a plurality of users; calculating an aggregate estimate for the real property based on the plurality of estimates; receiving a request for the aggregate estimate from a remote computing device of a user; and sending the aggregate estimate to the remote computing device for display to the user.

### CROSS-REFERENCE TO RELATED APPLICATIONS

The present patent claims the benefit of U.S. Provisional Patent Application 62/153,428, filed 27 Apr. 2015, titled “CROWD SOURCING REAL ESTATE VALUATION ESTIMATES,” and claims the benefit of U.S. Provisional Patent Application 62/169,284, filed 1 Jun. 2015, having the same title, the contents of each of which are hereby incorporated by reference for all purposes.

### BACKGROUND

1. Field

The present invention relates generally to distributed computing applications and, more specifically, to crowd sourcing real estate valuation estimates.

2. Description of the Related Art

Real estate websites generally provide, via the World-Wide Web, information about real property, such as residential properties and commercial properties. Often these services host searchable records about various properties for sale, such as residential homes for sale in a user-specified zip code. In many cases, the websites include information for users to contact listing agents to make offers on houses and advertisements related to the geographic area in which the user is searching.

Many existing real estate websites suffer a number of deficiencies. For example, some websites provide an estimate of a property's value, but these estimates are often found by property owners and realtors to be inaccurate and opaque. In many cases, these estimates are generated algorithmically based on a discrete set of features of a property and neighborhood, without including human input by those knowledgeable of the property or the surrounding area. In non-disclosure states, where home sale price data is considered private, these algorithmic estimates may not incorporate this critical information which would be readily available to a realtor. Absent these inputs, the estimates are often inaccurate and, because the methods of algorithms are kept secret, the considerations and freshness of the results are unknown to consumers. Inaccurate and opaque estimates are particularly a problem during real estate transactions, as they may lead home sellers or homebuyers to have unrealistic expectations about what is achievable in a transaction.

Other sources for estimates of a property's value exist. Often a buyer or seller will request a market survey in relation to a particular unit of real property by a realtor. These market surveys are expected to be relatively accurate, but the service is not widely provided, as such analyses often presuppose an existing relationship between the realtor and the recipient. Further, establishing these relationships can be difficult, as home buyers or sellers often do not have good metrics about the historical performance of those providing the estimates. Finally, such estimates are often prepared by a relatively small number of estimators, such as one, which can lead to outlier predictions being presented to home buyers or sellers on occasion.

In another deficiency, many real estate websites only allow buyers to search on listed properties, and buyers cannot search information on unlisted properties. Buyers, in some systems, can only learn property information through agents, but those buyers cannot communicate with sellers or homeowners directly. Further, many existing real estate websites have no marketplace for agents to compete to represent clients (buyers and sellers). Home owners in many existing systems have no place to see levels of interest in their property, or to find the pool of buyers who have interest.

One reason for some of these messaging issues with conventional systems is that existing messaging systems are not suitable for allowing buyers to communicate with homeowners directly. Often the buyer only knows the mailing address or identity (e.g., unique location) of the property, not of the owner, so contacting the owner is difficult. And to the extent users might self-identify to a messaging system as the owner of a given property, verification of ownership is often lax, e.g., being based solely on knowing the owner's name and the property address, leaving room for misrepresentations of ownership and abusive use of such messaging systems. Further, existing messaging systems do not serve the interests of other stakeholders in the home buying process, such as local multiple listing services, realtors, mortgage brokers, home inspectors, movers, and home renovation specialists.

### SUMMARY

The following is a non-exhaustive listing of some aspects of the present techniques. These and other aspects are described in the following disclosure.

Some aspects include a process including obtaining a plurality of estimates for a value of a real property from a plurality of users; calculating an aggregate estimate for the real property based on the plurality of estimates; receiving a request for the aggregate estimate from a remote computing device of a user; and sending the aggregate estimate to the remote computing device for display to the user.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 shows an example of a property-messaging system in accordance with some embodiments of the present techniques;

FIG. 2 shows an example of a process for messaging real property owners in accordance with some embodiments of the present techniques;

FIG. 3 shows an example of a process for crowd sourcing estimates of real property values, in accordance with some embodiments of the present techniques;

FIG. 4 shows an example of a process for measuring the historical performance of estimators of real property values in accordance with some embodiments of the present techniques;

FIG. 5 shows an example of a process for measuring interest in geographic areas according to demographic attributes; and

FIG. 6 shows an example of a computer system by which the above processes and systems may be implemented.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the real estate website field. Indeed, the inventors wish to emphasize the difficulty of recognizing those problems that are nascent and will become much more apparent in the future should trends in real estate continue as the inventors expect. Further, because multiple problems are addressed, it should be understood that some embodiments are problem-specific (e.g., transparency in valuation, accuracy in valuation, and messaging), and not all embodiments address every problem with traditional systems described herein or provide every benefit described herein. That said, improvements that solve various permutations of these problems are described below.

Some embodiments implement a technologies for crowd sourcing real property valuation estimates and for creating a community of verified homeowners and homebuyers, which can be leveraged by the owners and buyers for activities including various permutations of the following: 1) Indicating interests in a property or transaction, even if in the future; 2) Finding buying opportunities not on Multiple Listing Service (MLS) listings (e.g., providing a pre-market marketplace); 3) If desired, conducting transactions online (e.g., sales, rentals) with the assistance of a realtor or directly; and 4) Letting agents compete to be a listing or buyer's agent.

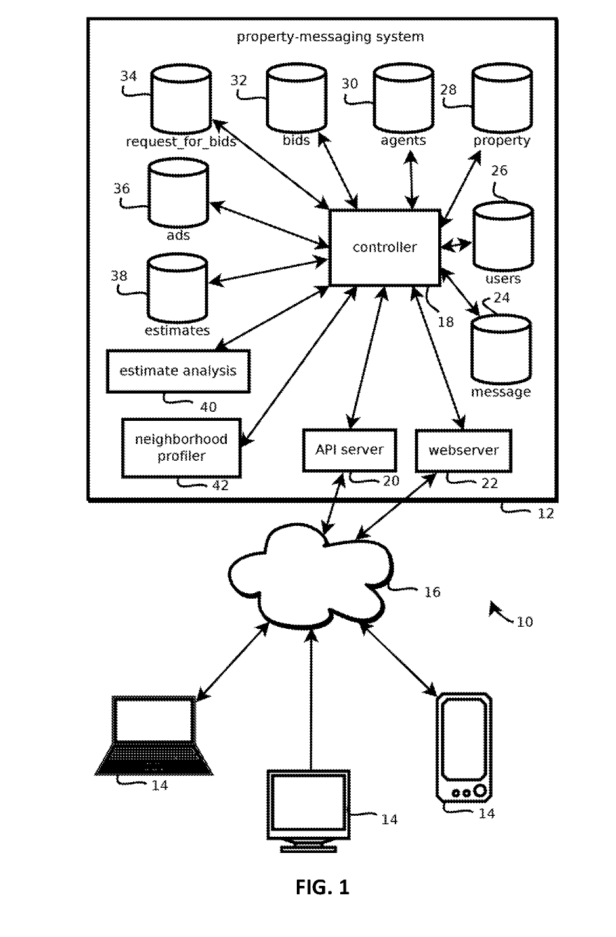

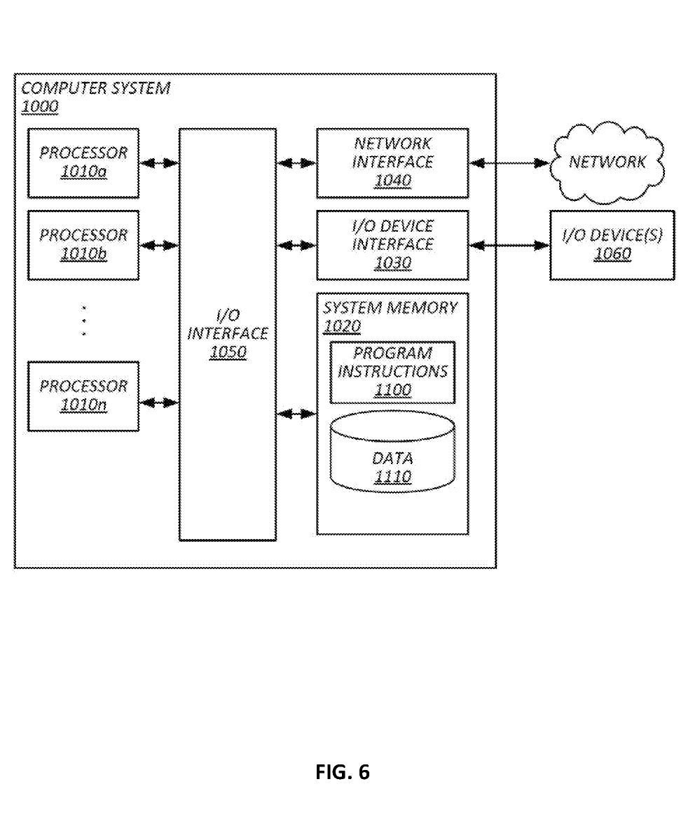

FIG. 1 shows an example of a computing environment 10 that, in some embodiments, address various subsets, and in some cases all, of the problems with traditional real estate websites discussed above. In this example, the computing environment includes a property-messaging system 12 connected to three illustrated user computing devices 14 via the Internet 16. Each of these components may include various numbers of computing systems, each of which may be like those described below with reference to FIG. 6. In some embodiments, the property-messaging system may include such computers executing various servers, and in the case of the three user devices, such computers may be obtained by users in the form of laptops, desktops, tablets, smart phones, wearables, set-top boxes, in-dash automobile computers, and the like.

In FIG. 1, only three user devices are shown by way of example, but in commercial embodiments, the number of user devices is expected to be relatively large, for example, numbering in the millions or tens of millions. The user base is expected to be geographically distributed, for example, over the entire United States, over the continent of North America, or around the world. As such, some embodiments may be designed to mitigate latency-related issues that tend to arrive at such scales, for instance, by providing responses to requests within less than 500-ms by, for example, by using content delivery networks; geographic replicated servers, content addressable data structures; and indexing, replication, and pre-sorting of records.

In some embodiments, the property-messaging system may allow a buyer, operating one of the user devices 14 shown, to communicate with a property owner, operating another of the user devices 14. In some cases, the property owner has not yet listed their property as being for sale, and in some cases, the property owner has not yet registered with the property-messaging system, before the buyer submits a message for the property. Thus, in some use cases, buyers can leave messages for property owners, such as expressions of interest in purchasing a given property, without having to wait for those property owners to identify themselves or register with the property messaging system. In this example, property owners can later register with the property-messaging system and receive messages about their property approximately immediately, such as messages having been sent over the previous several months. That said, messages may also be sent in some embodiments to property owners who have already registered. Some embodiments of the property-messaging system can print and send a postcard, or other parcel, such as a letter, addressed to the property owner (even if not registered or verified by the system) to let them know that a message is waiting for them, or the buyer can request such a process, which can include an extra charge to the buyer.

In some cases, a verification process is used to confirm that those registering as the owner of a given property (e.g., claiming the property in the system 12) are likely to be the owner of the property to avoid various forms of malfeasance, such as antagonistic neighbors registering as the owner of a neighboring property and responding in a way calculated to messages to drive away buyers. In one example of a verification process, some embodiments of the property-messaging system may print a postcard, or other parcel, such as a letter, addressed to a mailing address of a property to be verified and including a unique and difficult to guess code, along with instructions to log into the property-messaging system and enter the code to verify ownership. Upon receiving the code, the system 12 may send an interface (e.g., such as a webform sent to device 14) by which the user registers and can begin receiving messages for that property. Thus, in some cases, receiving mail addressed to a given property may be used as a proxy for ownership, or at least control of the property, sufficient to warrant access to the messages for that property. In some cases, additional checks may be used, such as requesting the owner to send in a photocopy of a bill, reconciling ownership with the county land office, or sending a person to walk door-to-door and verify ownership. Upon detecting an inconsistency, some embodiments may deny access to the messages until the inconsistency is reconciled.

The property-messaging system may be used in a variety of different capacities depending upon the role of the user. In one example, a buyer may navigate to the property-messaging system, for example, with a web browser or by launching a special-purpose native application on a mobile device 14, and enter a search query for properties, such as for properties in a specified geographic area (like a zip code) and satisfying certain other criteria, such as single-family homes, properties likely worth less than a certain amount of money, or the like. In some cases, through requests sent from device 14 to system 12 over the Internet 16, the buyer may specify that they are only interested in seeing homes that are listed on the local multiple listing service (MLS); the buyer may specify that they are interested in seeing only homes that are not yet listed; or the buyer may specify both homes that have been listed and homes that have not. The property-messaging system 12 may query a property data repository 28 and send the buyer's user device 14 a list of responsive properties and instructions to display those properties. The buyer may then select one of the listed properties, for example, by clicking on an icon on a map or selecting a given uniform resource locator (URL), indicating to the property-messaging system the buyer's interest in that property. In response, the property-messaging system 12 may send the buyer information about the property, such as whether it is for sale, whether the property has been claimed by an owner to whom they can communicate, whether the properties is for rent, and various other facts about the property, e.g., the size, estimated value, taxes, and the like. The user may, in some cases, be afforded the opportunity to designate the property as a favorite, such that they can later readily find the property.

In some cases, if the property is determined to be claimed by a verified owner, the buyer may be presented with an interface (e.g., their device 14 may be sent instructions to display a graphical user interface by system 12) by which the buyer may send a message to the property owner. Or in some cases, the buyer may be presented with the option to send such a message without regard to whether the property is claimed by a verified owner. In some cases, some embodiments may determine whether a property is listed under a real estate agent, in which case the buyer's communication may be directed to the agent, rather than to the owner, or to both. In some cases, buyers may choose to register with the property-messaging system, thereby creating a more expansive user profile for things like storing favorites. Some embodiments are agent friendly and will let an agent act on behalf of an owner or buyer. For example, an owner's listing agent can see buyers who have stated an interest in the property and communicate with them on behalf of the owner, in some embodiments.

Various kinds of messages may be sent between devices 14 via system 12, including prose composed by the buyer, such as in the format of an email, including a subject and a body, or some embodiments may include an interface (sent by system 12 to device 14) by which the buyer selects among pre-composed options to communicate (selected messages being returned by device 14 to system 12). Examples of such options include a list of messages, like “I am interested in buying your home,” “I am interested in renting your home,” “have you been happy living on this street?,” “any complaints with your homebuilder you are willing to share?,” and the like. In some cases, multiple lists of such options may be presented, so that the buyer can compose a message by selecting among each list. Another list may include attributes of the buyer, such as checkboxes that the buyer can select, like whether the buyer is a cash buyer, whether the buyer is prequalified for a sufficiently large mortgage, whether the buyer's offer would be contingent on the sale of another house, and the like. In some cases, the buyer may be presented with a field by which the buyer enters an amount they would be willing to pay for the house. Each piece of information entered by the buyer, in some cases, may be packaged together into a date stamped message associated with the buyer and with a unique identifier of the property at issue. In some cases, buyer attributes are captured as part of a separate workflow from messaging. For instance, during registration, buyers may be sent an interface by which they enter the various buyer attributes described herein. In some cases, potential sellers may be given access to some or all of these profiles, e.g., via a hyperlink associated with a message, to evaluate buyers, e.g., determine whether they are pre-qualified. Similarly, in some cases, owners may claim a property and edit a profile of the property, e.g., to correct errors in size, room count, school district, or the like. Also, in some cases, property owners may indicate the status of the property such as “Not for Sale,” “Rented Until August,” or (i.e., and/or) “Would Consider Selling,” and this status may be shown to prospective buyers or used to block messaging from buyers.

In some embodiments, a message may be algorithmically evaluated to determine whether the message is abusive, e.g., is spam or contains offensive language. For example, purchase amounts in offers may be compared against predicted values for the house, and messages conveying unreasonable offers may be deleted or down ranked when presenting messages to property owners by the system 12. For example, an offer for less than 50% of the predicted value of a property may cause that offer to be deleted or down ranked. Similarly, unreasonably high offers may also be deleted, such as an offer for more than 10 times the predicted value of the property. Further, when messages are presented to property owners, the property owner may be afforded an opportunity (e.g., presented an interface by which to effect the specified action) to designate a message as abusive or blatantly unreasonable. Some embodiments of system 12 may also search the text of messages for keywords that are offensive and, in response to finding such an offensive word, delete the message. In some cases, amounts of deleted messages may be associated with buyer profiles, and buyers with more than a threshold number of such flagged messages may be banned from the system. In some embodiments, buyers may be rate-limited by system 12 in the amount of messages sent in a given duration, e.g., limiting buyers to fewer than 100 messages in a given day to avoid spam. Thus, after receiving a message from a buyer, some embodiments may compare a count of messages over a trailing duration to a threshold and only send the message if the count is less than the threshold.

In some cases, upon a property receiving a message, embodiments of the property-messaging system may determine whether the property is claimed by an owner and, in response to such a determination, the owner may be sent an email, a text message, or the like to indicate that they should log in to the property-messaging system 12 to view the new message regarding the property. In some cases, upon determining that no owner has claimed the property, in response to such a message, or in response to a threshold amount (like a total quantity, a rate, or the like) of such messages, some embodiments of system 12 may cause a verification postcard, like those described above, to be sent to the corresponding property. (Sending such postcards can be expensive, so targeting the postcards to owners likely to respond due to pending messages is expected to save on postal fees.) In some cases, the printed message may include an indication of the number of messages waiting for the homeowner and, in some cases, indications of the amount that people are willing to pay for the house to entice homeowners to claim the property. (It should be noted that while some embodiments are described with reference to homeowners, embodiments are not limited to residential property and are applicable to, for example, commercial properties as well.)

Upon the homeowner logging in to the property-messaging system, the homeowner may see a list of messages for their property or properties. In some cases, a number of messages may have accumulated before the homeowner claims the property. Thus, homeowners, in some cases, have a relatively rewarding initial experience with the messaging system, in which they are immediately receiving messages about their property, e.g., during their first logged-in session.

In some embodiments, property owners may be afforded the opportunity, for example via a corresponding graphical user interface presented via one of the user devices 12 according to instructions sent by the property-messaging system 12, to respond to a message from a given buyer. In some embodiments, messages may be stored in and presented as threads, with a plurality of messages presented in chronological order and a given thread being defined by the initial message and responses and responses back to those responses.

Some embodiments of system 12 may define a mailing-address electronic messaging address namespace according to the physical mailing addresses of the properties in the property-messaging system, such that messages may be sent to a given property without logging into the property-messaging system 12. Such addresses, in some embodiments, may follow a predefined format such as street number_Street name_city_state@property-messaging.com. Embodiments may host an email server responsive to such addresses, adding emails to the message for the corresponding property. In other embodiments, the electronic messaging addresses may remain concealed within the property-messaging system to facilitate control of abusive messages and avoid programmatic spamming.

Some embodiments may maintain relatively rich user profiles based on past user behavior. For example, some embodiments may maintain a list of properties in which a given user has expressed interest and periodically process that list to infer attributes of the user, such as the types of properties in which the user is likely to be interested in the future. For example, some embodiments may analyze each of the properties in which the user has expressed an interest, for example, by converting a buyers messaging behavior into a vector and clustering the resultant vectors to identify patterns, such as a cluster of messages to single-family homes in high income zip codes with between three and four bedrooms, which may be used to identify properties in the future by system 12 having those attributes and to suggest those properties to the user. Similarly, some embodiments may process messages to which homeowners have responded to profile homeowners and rank or filter messages such that messages the homeowner is likely to respond to are presented with greater visual weight and ranking or are less likely to be filtered out of the system. In some embodiments, such profiles may be used to match homebuyers and property owners, for example, by determining that a given homebuyer sends the type of message that the property owner tends to respond to and that the property owner's home has the attributes that the given homebuyer tends to seek.

Some embodiments may facilitate access to various professionals related to the home buying process for users of the property-messaging system 12. For example, homebuyers may be asked in a user interface (sent by system 12 to device 14 for display, receipt of data, and to return data to system 12) whether they already have a realtor when sending a message and, in response to the user indicating that the answer is no, a realtor may be suggested to the homebuyer. In some cases, realtors may pay for such suggestions, or the homebuyer may be presented with an interface by which the homebuyer puts out a request for bids from realtors. Realtors may pay for placement in such suggestions or may pay for the right to bid on requests for bids put out by homebuyers. Home owners may be presented with a similar interface when viewing messages about their property. In cases where a homeowner is already represented by a realtor, messages relating to the property may be directed to the realtor or to both a realtor and the homeowner, thereby facilitating relatively simple communication between the relevant parties. In some embodiments, realtors may bid for the right to be the endorsed realtor in a given geographic area, and upon a property owner or a prospective buyer requesting a recommendation for a realtor, embodiments may determine the geographic area in which the realtor will be operating, and select the realtor that has paid to be the endorsed service provider in that area. In some embodiments, various other trades and professionals may be selected according to similar techniques, for example contractors, property inspectors, mortgage lenders, movers, and the like. Further, some embodiments may select advertisements to show alongside messages or properties, for example, based on the user profiles and attributes of the property being viewed or the message being viewed, such that relevant ads are shown.

To facilitate the operations described above, some embodiments may maintain various data repositories, such as databases, documents, program state, and the like. As shown, the property-messaging system 12 may include a property data repository 28, a user data repository 26, a message data repository 24, a request for bids data repository 34, a bids data repository 32, an agents data repository 30, an advertising data repository 36, and an estimates data repository 38. In some embodiments, the data repositories may be stored in a relational database system, with each repository residing in a different table, to avoid unplanned duplication of records an inadvertent inconsistencies. Examples of the types of data stored therein are described below.

In some embodiments, the property data repository 28 includes a plurality of property records, each property record including a unique property identifier, a messaging address (for example, in the email-like format described above), listing attributes (like whether the property is listed in the multiple listing service, the multiple listing service listing identifier, and an identifier of the realtor), an address (like a mailing address) of the property, a geolocation of the property (for example, a latitude and longitude or bounding polygon with vertices described by latitude and longitude coordinates), attributes of the property (like size, room count, bathroom count, whether it has a garage, a school district identifier, an indication of whether the property is single-family or multifamily, and the like), a record of the current owner (like a user identifier, an indication of whether the owner has been verified as the owner, the date the owner became the owner, and identifiers of messages to the current owner, such as messages sent subsequent to the date the property became owned by the current owner), a list of past owners, and frequently asked questions and answers regarding the property provided by the current owner. In some cases, owner may grow weary of answering the same question from each of the prospective buyers, so owners may be afforded the opportunity to submit a list of frequently asked questions and the answers to those questions, both of which may be presented to buyers when viewing the property. Property records may further include past sale prices, dates upon which the sales occurred.

In some embodiments, the user data repository 26 may include a plurality of user records, each user record including a unique user identifier, a user name, a password, contact information for the user (like an email address, a phone number, and a mailing address), an indication of whether the user has registered with the system, a list of property identifiers that the user has designated as favorites, a list of message identifiers of messages sent by the user, message filtering controls selected by the user (like whether the user has requested to block all messages, whether the user has white listed users from whom they will receive messages or blacklisted users from whom they refuse to receive messages, or various filters relating to other attributes of the messages, such as a request to only see messages with offers in a particular price range), properties owned by the user (such as a list of property IDs corresponding to records in repository 28), and a profile of the user (such as patterns in, or attributes of, properties owned by the user, properties message by the user, offers made by the user, messages to which the user responded, and a user-composed profile, for example, including photos, a bio, and a description of property sought by the user, which may be referenced in messages from the user).

In some embodiments, the message data repository 24 may include a plurality of message records, each message record corresponding to a given message and including a unique message identifier, a user identifier of the user who sent the message, a property identifier of the property to which the message is directed (which in some cases serves as the electronic address of the message), an indication of whether the message was read, an identifier of a thread to which the message belongs, a date the message was sent, a date the message was read, a subject of the message, a body of the message, various selections from predetermined message options like those discussed above, an indication of whether the message was flagged as abusive, and attributes of an offer, such as a price, an indication of whether the offer is contingent on the sale of another property, an indication of whether the offer would be paid in cash, an indication of whether the offer is conditional on repairs or is as-is, and an indication of whether the buyer is prequalified for the offer amount.

The request for bids data repository 32 may include a plurality of request for bids records, each record corresponding to a given buyer or seller requesting bids from a given category of professionals on a given task (like selling or buying a house, moving from one place to another, or financing a transaction). In some embodiments, each such record includes a unique request for bid identifier, a description of the transaction (like an identifier of the property and an identifier of the user submitting the request for bid), a list of bids that have been submitted, a start time for bidding, and end time for bidding, and an identifier of a winner if such a winner has been selected.

In some embodiments, the bid data repository 32 may include a plurality of bid records, each bid record representing a given submission for a given one of the request for bids by a professional. In some embodiments, each such record may include a unique bid identifier, an identifier of the professional, and terms of the bid, like a percentage of the purchase price that will be taken by the professional, a price for services, or the like. These bids may be presented to the user requesting bids at the time bidding ends (or before, e.g., as they arrive).

In some embodiments, the agent data repository 32 may include a plurality of agent records, each agent record corresponding to a given one of the above-described professionals. In some embodiments, each such record may include a unique agent identifier, an agent password for the system, an agent username for the system, an agent type (for example, whether the agent is a real estate agent, a mortgage broker, a mover, a home inspector, or the like), geographic areas served by the agent, a multiple listing service identifier of the agent, contact information of the agent, a subscription cost for the agent, a payment status for the agent, a subscription expiration date for the agent, and claimed geographic areas, such as a list of zip codes the agent has purchased as areas in which to be endorsed by the system and beginning and ending dates for those endorsement periods. In some cases, agents may subscribe to the system to receive leads or for the right to present ads or bid on requests for bids. Such subscriptions may be verified by an agent submitting credentials to log into the system, and those credentials may be compared to known credentials in the agent record, along with a subscription status. Upon system 12 determining that the credentials match, and the subscription status is active, certain features may be activated for the respective user. Some embodiments may allow people to use usernames rather than their real name to help protect their identity, although they can, in some implementations, choose to have their identity verified (even if that identity is not shared) to give them more credibility, and verification status may be displayed in user interfaces adjacent information about the agent.

In some embodiments, the advertising data repository 36 may include a plurality of advertising records, each advertising record including creatives (for instance, photographs, prose description, links, or references to such content by which advertisements are displayed), geographic locations to which the advertisement is to be targeted, attributes of properties to which the advertisement is to be targeted, and attributes of users to which the advertisement is to be targeted. Some embodiments may select among these ads when sending the various interfaces described here to show relevant ads to users.

The estimates repository 38 may include a plurality of estimate records, each estimate record corresponding to a single estimate provided by a user (e.g., submitted from device 14 in an interface provided by system 12 to gather estimate date that the interface sends to system 12) for a given instance of real property, such as a home. Each estimate record may include a unique identifier of the agent or other user that provided the estimate, which may correspond to a profile in the agent repository 30 or the user repository 26. Each estimate record may also include a timestamp of when the estimate was provided. Each estimate record may include a unique identifier of a property in property repository 28 to which the estimate pertains. Estimate records may further include a description entered by the estimator to explain the estimate, for example, an explanation that a particular property was valued lower than others in the neighborhood because that parcel is downwind from a sewage plant. In some cases, estimate records may also include identifiers of messages in message repository 24 associated with the estimate, such as messages back and forth between a homeowner and an estimator about a given estimate. In some cases, estimators may provide, and the corresponding record may include, a descriptive text provided in relation to a particular property to reflect the estimator's expertise, and this text may be publicly displayed. In some cases, estimate records may include scores, ratings, or commentary provided by other users to indicate confidence in the estimate or provide additional information which can help future estimates be more accurate. This information in the estimate records may be obtained upon the controller 18 sending instructions to user devices 14 to present a graphical user interface, such as in a webpage having form fields, that receive the information and send the information back to the controller 18 with an identifier that associates the information with the user providing information, such that the accuracy of a user's estimates may be tracked over time or over a geographic area or category of properties.

In addition to the above-described data repositories, the property-messaging system may include a number of modules that affect the operations described herein by cooperating with either a native mobile application executing on a user device 14 or a web browser executing on a user device 14 via the Internet 16. In some embodiments, the property-messaging system 12 includes a controller 18 that coordinates the server-side of the various activities described herein, including retrieving data from and writing data to the various data repositories and directing the activities of the various modules of the property-messaging system 12. In some embodiments, the property-messaging system includes an application program interface server 20 that interfaces with a native mobile application executing on the user devices 14 and, in some cases, third parties that syndicate content from the property-messaging system, as well as a webserver 22 that dynamically composes webpages to present the interfaces described herein to solicit the information from users described herein and to present the information to users described herein.

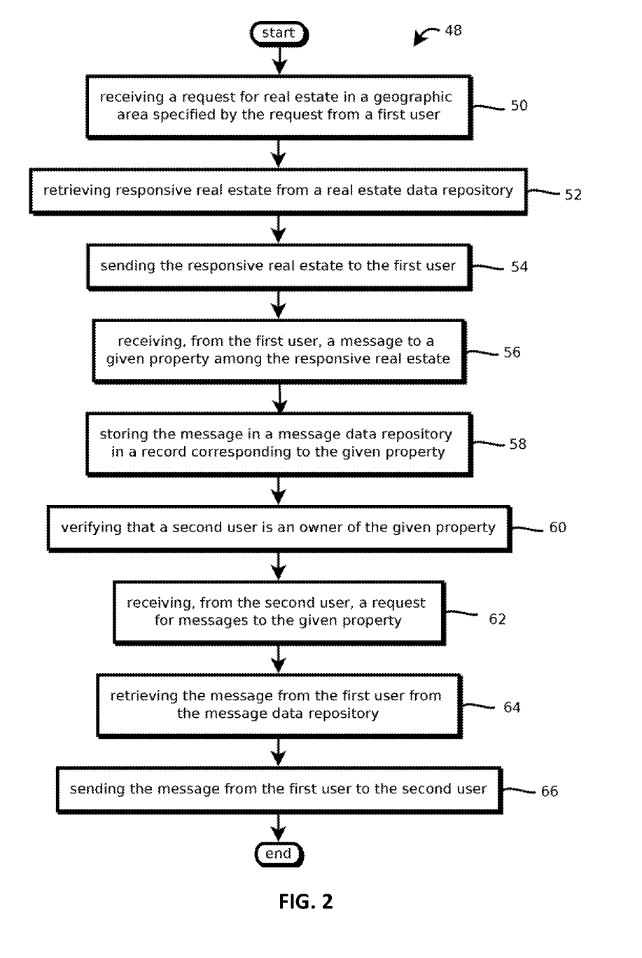

FIG. 2 shows an example of a messaging process 48 that may be performed by the above-described property-messaging system 12. In some embodiments, the process 48 includes receiving a request for real estate in a geographic area specified by the request from a first user, as shown in block 50. Next, the process 48 may include retrieving responsive real estate from a real estate data repository, as shown in block 52, and sending the responsive real estate to the first user, as shown in block 54. Some embodiments may further include receiving, from the first user, a message to a given property among the responsive real estate, as shown in block 56, and storing the message in a message data repository in a record corresponding to the given property, as shown in block 58. Some embodiments may further include verifying that a second user is an owner of the given property, as shown in block 60, and receiving, from the second user, a request for messages to the given property, as shown in block 62. Some embodiments may then retrieve the message from the first user from the message data repository, as shown in block 64, and send the message from the first user to the second user, thereby allowing to users to communicate with one another merely in virtue of the first user being able to identify the property, as shown in block 66.

Thus, some embodiments may facilitate messaging between home owners and interested parties, even when those home owners have not yet registered with the system 12, and when the message sender does not otherwise have contact information for the home owner.

Some embodiments may leverage the above-described systems and methods to provide home valuations powered by local agents with proven success, or some embodiments may provide these features independent of the systems and methods described above, as the following techniques are independently useful. As noted above, some embodiments provide a service to crowdsource better home valuations from (a) local agents (experts) who have bought and sold homes with similar characteristics (b) local non-agents (residents, investors, etc.) who have expertise in valuations in the area. Further, some embodiments may calculate a tiered indicator or number out of 100 that represents how “hot” or trending a neighborhood may be primarily amongst similar consumers based on social profiles, demographics, etc. . . . and either search or estimate/community activity (e.g., favorites, comments).

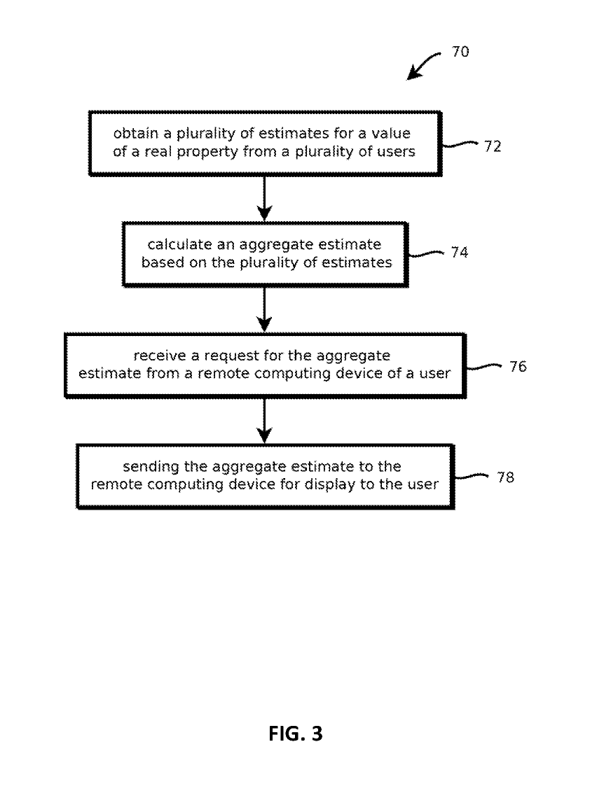

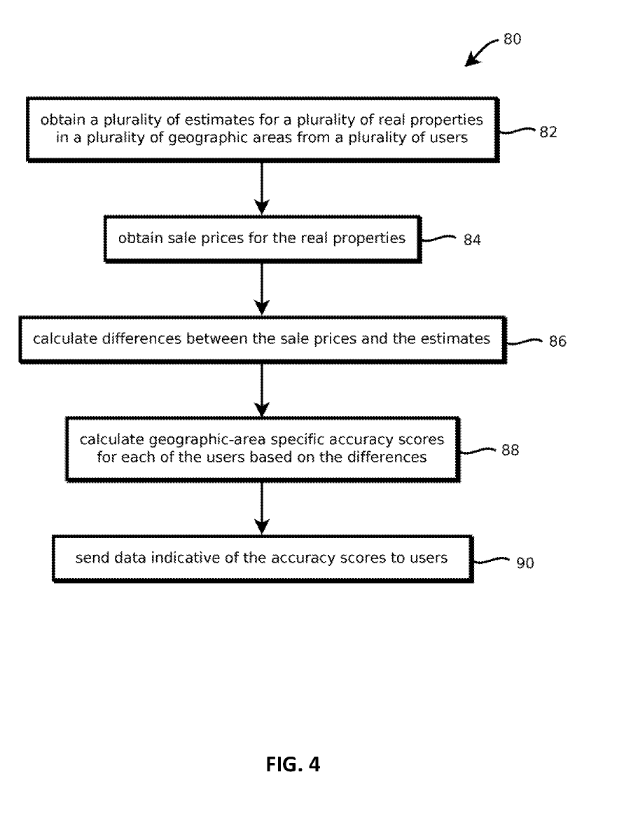

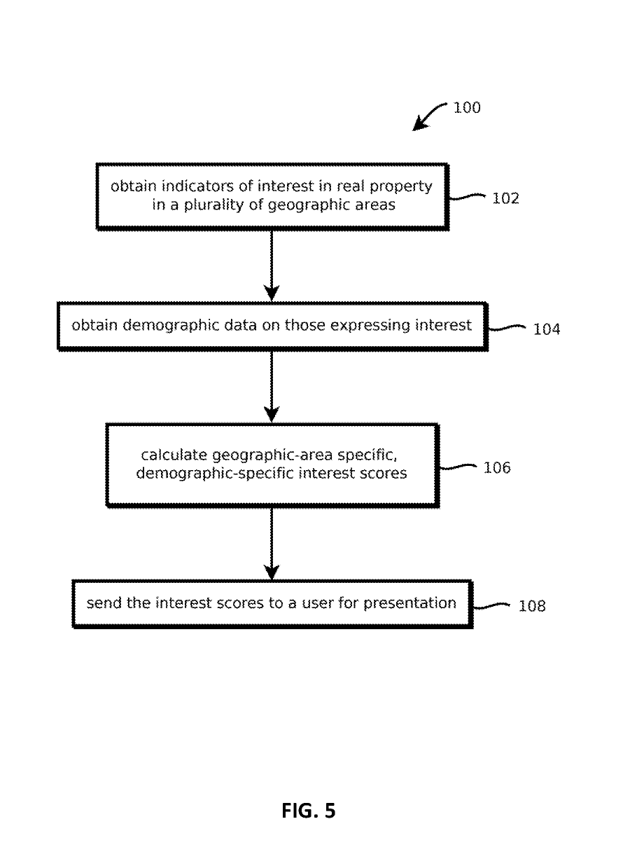

To these ends and others, in some embodiments, the property-messaging system 12 may execute one or more of the processes described below with reference to FIGS. 2 through 5. In some cases, the processes of FIGS. 3 through 4 may be used to crowd source estimates of real property valuations; and the process of FIG. 5 may be used to measure interest in various geographic areas among various demographic groups. These processes and the associated techniques may be used together in some embodiments, or the techniques may be used independently, as the various inventions described herein are separately useful.

In some embodiments, the property-messaging system 12 includes the estimates repository 38 and an estimates analysis module 40. These components 38 and 40 may cooperate with controller 18, API server 20 and webserver 22 to gather estimates from users (e.g., realtors or non-realtor users), aggregate those estimates, calculate statistics on the estimates and the accuracy of the estimators, and provide resulting data to user devices 14, for display to users. In some embodiments, the estimate analysis module 40 may perform one or more of the processes described below with reference to FIGS. 3 through 4, and the neighborhood profiler 42 may perform the process described below with reference to FIG. 5.

In some cases, as described below, estimates may be compared to subsequent sale prices for the corresponding properties to determine the accuracy of an estimate. To this end, in some embodiments, records for individual properties in property repository 28 may include sale prices and corresponding sale dates, obtained through a multiple listing service, a property tax authority, self-reported by users, or the like.

In some embodiments agent records in agent repository 30 may include unique identifiers of estimates in estimates repository 38 provided by the corresponding agent. Further, in some embodiments, user records and user repository 26 may include unique identifiers of estimate records of estimates provided by the corresponding user. In some cases, these agent records or user records may be updated, for example, periodically, to further include accuracy scores for the corresponding agent or other user. In some cases, such scores may be calculated with the process described below with reference to FIG. 4 by retrieving a collection of estimates corresponding to the individual's record in repository 30 or 24, retrieving sale prices for properties valued in those estimates from property repository 28, and calculating errors between the estimated and actual sale prices.

In some cases, agents or other users may attempt to cheat by submitting estimates that exactly match those provided by other web-based services, for instance, copying Zillow's Zestimate™ estimate as their own, or copying the estimates of another agent with high accuracy scores as their own to artificially rise above a low, initial level of accuracy scores. To prevent such cheating, some embodiments may periodically compare a plurality of estimates provided by each agent or other user to corresponding estimates for the same properties provided by each of the most popular third-party estimating services and top estimators and calculate a correspondence score (e.g., a correlation coefficient, such as a Pearson product-moment correlation coefficient) between each user's estimates and those of each third-party service or top estimator. Embodiments of the estimate analysis module 40 may determine whether any of the correspondence scores exceed a threshold and, in response to determining that a given correspondence score exceeds a threshold, either refuse to accept further estimates from a given user or send a warning to a given user that such copying is not permitted. Further, in some cases, estimates deem to be copied may be automatically deleted from the estimate records.

In some cases, estimates by other vendors, such as algorithmically generated estimates like the above-mentioned Zestimate™, may be obtained by the estimate analysis module. For instance, the module may send, via the Internet, requests to third party servers for such estimates, parse estimates from content received from the third party servers, and store the parsed estimates in records associated with the corresponding property, e.g., in further association with an identifier of the corresponding third party service. Upon sending an estimate to a user, some embodiments may retrieve these third party estimates and send the third party estimates to the user to be presented with the estimates obtained with the techniques described herein for comparison, e.g., with labels indicating the source of the third party estimation service.

Neighborhood profiler 42 may be operative to obtain demographic data about those who have expressed an interest in real property and calculate demographic statistics on various geographic areas describing that interest in the aggregate. To this end, neighborhood profiler 42 may perform a process described below with reference to FIG. 5.

In some embodiments, the estimate analysis module 40 may perform the process 70 of FIG. 3 to crowd source estimates of real property valuations. In some embodiments, the process may include obtaining a plurality of estimates for a value of a real property from a plurality of users, as indicated by block 72, e.g., the information in the estimate records described above. In some cases, the estimates may be obtained through a web form or a mobile device application, and the received estimates may be associated both with a record for an individual unit of property and a record for the user providing the estimates. In some cases, the plurality of estimates may be obtained over time from a relatively large number of users, such as several dozen users over a one, five, or ten year duration.

In some cases, the estimates are obtained from realtors that have subscriptions with the property-messaging system 12, or in some cases, the estimates are provided by interested layperson users that wish to measure and improve their ability to predict home valuations. In some cases, access to various features may be continent on having a subscription, e.g., realtors may need to subscribe to respond to user messages, to provide more than a threshold amount of estimates, or to bid on tasks. (Note, the term “realtor” is used herein to refer to real estate agents and is not limited to agents belonging to the National Association of Realtors.)

Next, some embodiments may calculate an aggregate estimate based on the plurality of estimates, as indicated by block 74. Calculating the aggregate estimate may include calculating a single value based on some (e.g. a plurality of) or all of the obtained estimates from step 72. For example, in some embodiments, the estimate analysis module 40 of FIG. 1 may calculate a measure of central tendency of the provided estimates, such as a mean, mode, or median estimated value. Some embodiments may calculate and report a trend in estimated value, for instance, a 12 month moving measure of central tendency calculated by determining, for each reported trendline point, which estimates fall within a trailing threshold duration of time, and for those estimates that satisfy the threshold, calculating the measure of central tendency for the respective trendline data point, repeating the process for each data point in the trendline. Some embodiments may calculate and report measures of variation in the provided estimates, such as a maximum and minimum (or range there between), a standard deviation, a variance, or the like. Trendlines over time for these reported measures of variation may also be calculated and reported using the aforementioned technique.

In some embodiments, calculating the aggregate estimate may include filtering the provided estimates to remove unreliable or otherwise undesirable estimates. For example, some embodiments may disregard estimates more than two standard deviations from a mean estimate, or those estimates falling outside some other threshold value. In another example, some embodiments may query repositories 26 or 30 for accuracy scores for the corresponding estimates (examples of which are described below with reference to FIG. 4) and filter out (e.g., disregard) estimates by those estimators that have accuracy scores that are below a threshold accuracy score. In some cases, the threshold accuracy score may be calculated relative to accuracy scores of other providers of estimates, for example, the bottom 10% of estimators by accuracy score may be disregarded when calculating the aggregate estimate. In some cases, accuracy scores specific to a geographic area including the real property at issue may be retrieved and used in determining which estimates to filter out, e.g., removing the bottom 10% for the zip code by accuracy score. Or accuracy scores specific to particular categories of real property including the property at issue may be retrieved and used in determining which estimates to filter out. In some embodiments, estimates that are more recent than a trailing duration may be filtered out. Home buyers may attempt to drive down the purchase process by coordinating efforts to submit numerous, low estimates of home value. To suppress the effectiveness of such techniques, estimates more recent than a trailing duration, such as more recent than two weeks prior, may be filtered out. Or some embodiments may risk such gaming of the system to obtain fresher estimate values, which is not to suggest that any other feature may not also be omitted in some embodiments. Thus, in some embodiments, the aggregate estimate may be based on the estimates that are not filtered out, and the aggregate estimate may be not based on the estimates that are filtered out.

Some embodiments may calculate a weighted combination of the obtained estimates, for instance a single aggregate value, a trendline, or the like, based on estimates that are not filtered out. In some cases, the weights may be calculated based on accuracy scores of the estimators. For example, accuracy scores of each estimator may be summed, and then the accuracy score of each respective estimator may be divided by the resulting sum to calculate a weight for the estimate provided by that estimator, thereby weighting estimates from historically more accurate estimators more heavily in the aggregate estimate. In some cases, accuracy scores specific to a geographic area or category of property including the property issue may be retrieved and used in calculating these weights.

Some embodiments may calculate multifactor weights for each estimate. For example, some embodiments may combine an accuracy score for all properties for a given estimator with an accuracy score for the geographic area or category of property including the property issue for the respective estimator. In some cases, such weights may further include a weight based on an age of the estimate, such that older estimates tend to be assigned lower weights in the weighted combination.

As noted above, each estimate may be associated with a timestamp indicating when the estimate was provided. In some embodiments, a difference between the current time and the timestamp for each estimate may be calculated to calculate an age of the respective estimate. In some embodiments, weights for each estimate may be calculated based on the ages, for example, a freshness weight may be calculated based on an offset summed with a coefficient multiplied by the age in days, with products below zero being assigned a zero weight. In another example, freshness weights may be calculated based on a half-life of the estimate weight (e.g., a half-life of six months), such that older estimate freshness weights asymptotically and monotonically approach some value, such as zero.

In some cases, a rate of decrease in (or decrease in half-life of) the freshness weight according to age may be calculated based on a volatility in prices in the overall geographic area or category of properties including the real property issue. For example, a freshness weight may be decreased according to age more quickly in a neighborhood that has a higher rate of change in property prices relative to a rate of decrease in freshness weight according to age in a neighborhood that has a lower rate of change in property prices. Accordingly, some embodiments may retrieve property records from the property repository 28 in a geographic area including the real property issue; bin those properties according to time bins (such as sales occurring in a given month for the previous two years); calculate an average for each of the respective time bins; and calculate an average change between consecutive time bins, or other measure of central tendency. This rate of change may be used to select a rate at which the freshness weight is decreased according to age of a respective estimate, e.g., with a lookup table mapping rates or half-lives to rates of change in property values.

In some cases, the aggregated estimate may be based on third-party estimates, such as by calculating a measure of central tendency from a plurality of estimates from real estate websites or from estimates by a county property tax assessing authority. In another example, the aggregate estimate may be based on sale prices of other properties within a threshold distance, such as within a given neighborhood, zip code, or within less than 1 kilometer, for example, or based on the price-per-square foot of such properties multiplied by a square footage of the property at issue.

In some embodiments, multi-factor weights may be calculated with a different emphasis on the different factors. For example, more emphasis (and weight) may be placed on accuracy in the given geographic area in the recent past (e.g., within the preceding year) than on accuracy over all estimates or ages. For instance, a weight for a given estimate may be calculated by summing the product of each factor and an emphasis coefficient (or sub-weight, which is a type of weight), and then normalizing the result, e.g., by dividing the result by the sum of the same values for each of the estimates at issue. In some cases, the aggregate estimate may be combined with the third-party estimates in a combination based on the emphasis coefficients, for example, with a coefficients of 0.50 for realtor estimates (e.g., a coefficients of 0.20 for third-party estimates, a coefficient of 0.10 for freshness, a coefficient of 0.10 for realtor accuracy score, a coefficients of 0.05 for non-realtor user estimates, and a coefficient of 0.05 for non-realtor accuracy scores.

Emphasis coefficients and other weights may be determined empirically, e.g., by iteratively adjusting the coefficients to reduce or minimize a cumulative error (or measure of central tendency in error) between earlier estimates and resulting sale prices, e.g., by iterating through each permutation of coefficient values at some step size (e.g., 0.01), calculating the error when applied to historical data, and selecting the permutation of coefficient values that yields the lowest error among the candidates. In some cases, these and the other weights and coefficients described herein may be adjusted over time with this technique, e.g., periodically, like weekly or monthly.

In some embodiments, some or all of the weights or coefficients described herein may be calculated by executing a machine learning algorithm on a training set of historical estimates and corresponding sale prices. Some embodiments may execute a gradient descent optimization to reduce the error rate and select appropriate weighting and the threshold values, such as those used in filtering. The estimates and the sale prices may be timestamped to allow for calculation of the freshness weight, and the accuracy scores and other profile parameters of the various estimators may be included in the set to calculate weights for accounting for the historical accuracy of the estimators. In some cases, a predictive model (e.g., a vector of weights) may be calculated as a batch process run periodically. Some embodiments may construct the model by, for example, assigning randomly selected weights; calculating an error amount with which the model describes the historical data and a rates of change in that error as a function of the weights in the model in the vicinity of the current weight (e.g., a derivative, or local slope); and incrementing the weights in a downward (or error reducing) direction. In some cases, these steps may be iteratively repeated until a change in error between iterations is less than a threshold amount, indicating at least a local minimum, if not a global minimum. To mitigate the risk of local minima, some embodiments may repeat the gradient descent optimization with multiple initial random values to confirm that iterations converge on a likely global minimum error. Other embodiments may iteratively adjust other machine learning models to reduce the error function, e.g., with a greedy algorithm that optimizes for the current iteration. Because model optimization is expected to be relatively computationally time and resource intensive, the training routing may be run in advance of when the model is used. The resulting, trained model, e.g., a vector of weights or thresholds, may be stored in memory and later retrieved for application to calculate aggregate estimates based on newly received data outside of the training set.

In some embodiments, aggregate estimates may be calculated periodically, for example, daily, or in response to a particular event, such as the receipt of a new estimate. In some cases, weights for combining estimates may be calculated periodically as well, for example, daily or monthly. Pre-calculating aggregate estimates is expected to facilitate relatively fast responses to user requests to view aggregate estimates, though some embodiments may calculate aggregate estimates at query time, particularly in smaller implementations. The aggregate estimates may be stored in property records in the property repository 28 for relatively fast retrieval when sending information about a given property.

Next, some embodiments may receive a request for the aggregate estimate from a remote computing device of the user, as indicated by block 76. The user may be a different user from the users that provided the plurality of estimates in step 72, or one of the estimates in step 72 may be provided by the user of step 76. In some embodiments, the request may be a hypertext transport protocol request for web content, such as a webpage, pertaining to a particular real property identified in the request, such as a request for a webpage about a particular residential property. In other examples, the request may be an API request, for instance, from a mobile web application, for data to populate a graphical user interface on a mobile user device that displays at least some of the same information.

Next, some embodiments may send the aggregate estimate to the remote computing device for display to the user, as indicated by block 78. Sending the aggregate estimate may include sending additional information about the real property, such as the location, square footage, lot size, number of bedrooms, number of bathrooms, listing agent, multiple listing service identifier, photographs of the real property, and the like. In some cases, some or all of the obtained estimates may be sent as well, for instance, with links to information about the person who provided the estimate (e.g., a uniform resource identifier (URI) that resolves to a responsive action by the property-messaging system 12), such as contact information for the person who provided the estimate. In some cases, the estimates may be provided in rank order based on the accuracy of the estimators historically, for instance, with the most accurate estimator in a given neighborhood, a given property category, or overall, ranked at the top of a list. In some cases, the estimators may be identified with the accuracy scores and links to additional information about the respective estimators. In some embodiments, the links may be URIs that direct the property messaging system 12 to obtain the information about the respective estimator and provide that information. In some embodiments, the estimates may be displayed in association with a description provided by the estimator for why they chose the estimate they chose, such as a note about some idiosyncrasy of the property, and a note about why the estimator is qualified. In some cases, estimates or comments from non-realtors may be visually distinguished from that of realtors when presented on user devices.

In some embodiments, lead generation may be tracked. For instance, when a user selects a link to contact or obtain additional information about or from an estimator, that request may be logged by the property messaging system 12, and a report may be presented to the estimator, for example monthly, indicating an amount of leads generated by subscription to the property messaging system 12. Or in some cases, estimators may be billed for each lead provided by the property messaging system 12 based on, for example, a count of a number of times contact information was provided, a number of times the estimate was presented, a number of times a bio of the estimator was displayed, or number of times that a user contacted the estimator through the property messaging system 12. Or in some cases, leads may be rate limited based on whether the estimator (such as an agent) subscribes to the system 12, e.g., five leads per month free, with charges accruing to receive more.

FIG. 4 illustrates an example of process 80 for calculating accuracy scores for estimators, such as realtors or other users of the property messaging system 12. In this embodiment, the process 80 begins with obtaining a plurality of estimates for a plurality of real properties in a plurality of geographic areas from a plurality of users, as indicated by block 82, such as those in the estimate records described above.

In some cases, the number of estimates, properties, geographic areas, and users may be relatively large, for instance with properties numbering in the millions, estimates numbering in the hundreds of millions, geographic areas numbering in the tens of thousands, and users numbering in the hundreds of millions. Accordingly, in some embodiments, the steps of the processes described herein may be executed concurrently for different sessions or analyses (e.g., analyzing estimators concurrently on different computing devices), and various data structures to facilitate relatively prompt access to data may be used, for example, replicating records, and pre-indexing or sorting records to facilitate relatively fast access according to various key values, such as unique property identifiers, user identifiers, agent identifiers, and the like. In some embodiments, the plurality of estimates may be obtained over a relatively long period of time, such as over a trailing duration of one year to ten years. In some embodiments, a given user may have submitted hundreds of estimates for hundreds of properties in dozens geographic areas, such as in various neighborhoods or zip codes in a city in which they have a real estate practice.

In some embodiments, the obtained estimates may be filtered to remove estimates that are relatively old from consideration, as a user's skill in estimating property valuations may improve over time. For instance, some embodiments may discard estimates that are more than two years old. Or in some cases, a threshold number of estimates may be discarded, such as estimates older than the estimator's most current 100 estimates. In some cases, these thresholds may be adjusted based on a rate of submissions of estimates by an estimator, with a relatively high rate causing less old estimates to be discarded, as the user may be experiencing a relatively high rate of learning, and those older estimates may be less probative of the user's current estimating skill. In another example, these thresholds may be adjusted based on a rate of change in property values in the geographic area, using the techniques described above to measure the rate of change, such that higher rates of change in property values may cause less old estimates to be discarded.

Next, some embodiments may obtain sale prices for the real properties, as indicated by block 84. Sale prices may be obtained with a variety of techniques. For example, in some states, sale prices may be reported to a county property taxing authority, which may publish the sales prices, and the real property sale prices may be obtained from a website of that property tax authority. In another example, such sale prices may be obtained through a subscription to a multiple listing service in a local geographic area that grants access. In another example, sale prices may be self-reported by agents or by users. In some embodiments, upon a sale being reported by an authoritative source, such as an agent, multiple listing service, or county taxing authority, or person who previously claimed the property, the record indicating the property is claimed may be updated to reflect the property is currently unclaimed by the new owners, and the techniques described above for determining when a property is claimed may be executed.

In some cases, obtained sale prices may be validated to determine whether the sale price is plausible. For example, a reported sale price may be compared to a distribution of sale prices for properties in the surrounding geographic area, for instance, a distribution of price per square foot in the same neighborhood, same zip code, or surrounding 1 kilometer radius. A reported sale price may be discarded by system 12 in response to determining that the reported sale price is an outlier. For instance, reported sale prices more than four, five, or six standard deviations (chosen depending on tradeoffs between false positive and false negative rates) from a mean sale price in a geographic area may be discarded. The obtain sale prices may be stored in association with the corresponding property records in the above-described property repository 28.

Next, some embodiments may calculate differences between the sale prices and the estimates, as indicated by block 86. In some embodiments, for each estimate provided for a given property, the sale price of that given property may be subtracted from the estimate to calculate an error for the corresponding estimate. The errors may be stored in association with the estimates, in the estimates repository 38 described above.

Next, some embodiments may calculate geographic-area specific accuracy scores for each of the users based on the differences, as indicated by block 88. In some embodiments, the accuracy scores may be a measure of central tendency of the differences, such as mean, mode, or median difference. In some embodiments, a measure of variability of the differences may be calculated, such as a standard deviation, a max and min (or range therebetween), or a variance. In some embodiments, trendlines for the measure of central tendency or the variability may be calculated, for example using the trailing duration thresholding techniques described above. A plurality of accuracy scores and measures of variability and trendlines may be calculated for each user, each according to a different subset of the differences, for example, differences in each of a plurality of different geographic areas, differences in each of a plurality of different categories of real property (e.g., single family, multifamily, commercial, or industrial real property), or combinations thereof. In some embodiments, the accuracy scores may be normalized, for example, by dividing the differences by the sale prices to calculate percentage errors, which may be used to calculate accuracy scores.

In some cases, accuracy scores may be adjusted based on an amount of estimates provided by a given user. Some realtors may be tempted to game the system by only providing estimates when the risk of error is relatively low, for instance, only providing estimates for real properties next door to, and nearly identical to, a recently sold property. Such behavior would allow those realtors to potentially conceal their real ability to estimate. Accordingly, in some embodiments, accuracy scores may be decreased based on an amount of estimates provided, for instance, multiplying the accuracy scores by a coefficient that ranges from 0 to 1 linearly as the number of estimates ranges from 0 to 100. In another example, realtors may be encouraged to only estimate when they are highly confident, and such coefficients may not be used, which is not to suggest that any other feature may not also be omitted in some embodiments.

In some embodiments, estimates may be obtained with confidence scores submitted by the estimator, and accuracy scores may be a weighted combination of the differences, with the weights based on the confidence scores self-reported by the estimators. For example, differences associated with an estimate in which the confidence score was relatively high may be afforded a greater weight in the combination. In some cases, the confidence scores may be summed, and each error from estimate may be assigned a weight correspond to the respective confidence score divided by the sum of confidence scores. Resulting accuracy scores may be reported with a measure of central tendency of the confidence scores to document both a realtor's confidence, accuracy, and self-awareness of their own areas of expertise.

In some embodiments, the differences may be weighted based on the age of the respective estimates relative to the sale date. For instance, a freshness weighting like those described above may be calculated and multiplied by the respective differences, the product of which, when summed, may form an age weighted combination of differences that weights older estimates relative to the sale date less than more current estimates relative to the sale date.

In some embodiments, the accuracy scores may be pre-calculated to facilitate relatively fast retrieval and display of such scores when queried. In some embodiments, the accuracy scores may be calculated periodically, for example weekly or monthly. The resulting accuracy scores may be stored in corresponding agent or other user records in the repositories 30 or 26 respectively.

In some embodiments, the process 80 may include sending data indicative of the accuracy scores to users, as indicated by block 90. Sending the data indicative of the accuracy scores may include sending a webpage that when rendered displays a plurality of the above described statistics for a given agent, presents a plurality of such agents ranked according to one or more of the above described statistics (for instance, showing the top agents by accuracy in a geographic area, in a category of real estate, or combination thereof), or the like. In some embodiments, the tracking of accuracy scores and estimates may be gamified for agents and other users. For example, some embodiments may determine when a given user has submitted more than a threshold amount of estimates in a given category of real estate, a given real estate area, or combination thereof, and in response, the profile of that user may be associated with a virtual rewards, which may be displayed in a profile of that user when requested by a user device 14. In another example, some embodiments may calculate aggregate expertise stores for users in a given geographic area, category of real estate, or combination thereof. Expertise scores, in some embodiments, may be a weighted combination of an amount of time the user has had a subscription with the real property messaging system 12, an amount of interactions (e.g., property submissions, messages, estimates, and the like) with the property messaging system 12 by the respective user, and accuracy scores for the respective user. In some embodiments, the property messaging system may send to user devices information and instructions to display such expertise scores.

Some embodiments may perform a process 100 shown in FIG. 5 to calculate various demographic, geographic area-specific statistics on users' (and other peoples′) interest in real property. Some embodiments may include obtaining indicators of interest in real property in a plurality of geographic areas, as indicated by block 102. Next, some embodiments may obtain demographic data on those expressing interest, as indicated in block 104. Demographic data may include the following: age, gender, salary range, employer, social network profile attributes, and family status, e.g., with our without children. Such information may be self-reported by users when populating user profiles, or information may be obtained from third parties, e.g., census data. Next, some embodiments may calculate geographic area specific, demographics they get specific interest scores, as indicated by block 106. For interest, some embodiments may calculate a rate (e.g., over time, or per square mile) at which women, age 30-40, with children, employed in retail, send messages relating to properties in two geographic areas. Or some embodiments, may calculate for a different demographic group a rate (e.g., over time, or per square mile) at which estimates are provided for two geographic areas. Next some embodiments may send the interest scores to a user for presentation, as indicated by block 108. Sending interest scores may include sending heat maps based on such scores, e.g., in response to a user submitting a query for interest of a specified type (e.g., messages, estimates, requests for bids, claiming, sales), among a specified demographic group, in a specified area.

FIG. 6 is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices).

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present invention may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several inventions. Rather than separating those inventions into multiple isolated patent applications, applicants have grouped these inventions into a single document because their related subject matter lends itself to economies in the application process. But the distinct advantages and aspects of such inventions should not be conflated. In some cases, embodiments address all of the deficiencies noted herein, but it should be understood that the inventions are independently useful, and some embodiments address only a subset of such problems or offer other, unmentioned benefits that will be apparent to those of skill in the art reviewing the present disclosure. Due to costs constraints, some inventions disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such inventions or all aspects of such inventions.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. The term “each” does not mean “each and every,” unless otherwise indicated. Further, unless otherwise indicated, statements that one value or action is “based on” another condition or value encompass both instances in which the condition or value is the sole factor and instances in which the condition or value is one factor among a plurality of factors. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

The present techniques will be better understood with reference to the following enumerated embodiments:

1. A method of crowdsourcing valuations of real property from real estate agents and other users, the method comprising: obtaining, with one or more processors, a plurality of estimates for a value of a real property from a plurality of users; calculating, with one or more processors, an aggregate estimate for the real property based on the plurality of estimates; receiving, with one or more processors, a request for the aggregate estimate from a remote computing device of a user; and sending, with one or more processors, the aggregate estimate to the remote computing device for display to the user.
2. The method of embodiment 1, wherein at least some of the plurality of estimates are obtained from a plurality of realtors by performing steps comprising: receiving realtor credentials from another computing device of a respective realtor among the plurality of realtors; identifying a respective realtor user account based on the credentials; sending information about the real property to the other computing device of the respective realtor; receiving a respective estimate among the plurality of estimates from the other computing device of the respective realtor; and after identifying the realtor user account, storing the estimate in association with a record of the real property and in association with the respective realtor user account.
3. The method of embodiment 2, comprising: obtaining other estimates for a plurality of other real properties from a given realtor among the plurality of realtors; obtaining sale prices for the plurality of other real properties; calculating a plurality of estimation errors based on differences between the other estimates and the sale prices; and calculating an accuracy score for the given realtor based on the plurality of estimation errors.
4. The method of embodiment 3, comprising: identifying a plurality of realtors, including the given realtor, that provided an estimate for the value of the real property; and sending the remote computing device of the user instructions to display the at least some of the plurality of realtors in ranked order based, at least in part, on the accuracy score of the given realtor relative to accuracy scores of at least some of other realtors among the plurality of realtors.
5. The method of any of embodiments 1-4, comprising: after sending the aggregate estimate, receiving a request from the remote computing device for contact information for a given realtor that provided one of the estimates among the plurality of estimates; sending the contact information to the remote computing device of the user; and updating a realtor profile for the given realtor to reflect provision of a lead.
6. The method of any of embodiments 1-5, comprising: sending, to the remote computing devices, at least some of the plurality of estimates and descriptions of reasons for the at least some of the sent estimates provided by estimators.
7. The method of any of embodiments 1-6, wherein calculating the aggregate estimate comprises calculating a measure of central tendency of the plurality of estimates.
8. The method of any of embodiments 1-7, wherein: calculating the aggregate estimate comprises: obtaining a respective accuracy score for estimators providing at least some of the plurality of estimates; calculating the aggregate estimate based on both the accuracy scores and the plurality of estimates.
9. The method of embodiment 8, wherein calculating the aggregate estimate comprises: filtering out estimates based on accuracy scores before calculating the aggregate estimate based on estimates that are not filtered out.
10. The method of any of embodiments 8-9, wherein calculating the aggregate estimate comprises: calculated a weighted combination of the plurality of estimates.
11. The method of embodiment 10, wherein weights are based on accuracy scores such that lower accuracy scores tend to correlate with lower weights.
12. The method of embodiment 10, wherein weights are based on an age of the respective estimates of the plurality of estimates such that older estimates tend to correlate with lower weights.
13. The method of embodiment 10, comprising: learning the weights with one or more processors by executing a gradient descent algorithm on a training set of historical estimates and sale prices.
14. The method of any of embodiments 1-13, comprising: receiving a message to a real property owner from a realtor providing at least one of the plurality of estimates; receiving a communication from the user of the remote computing device indicating that the user owns the real property; determining that the real property is claimed by the user; and in response to determining that the real property is claimed by the user, sending the message from the realtor to the real property owner.
15. The method of any of embodiments 1-14, comprising: calculating accuracy scores for a plurality of realtors in a plurality of geographic areas, each realtor having a plurality of accuracy scores for each of at least a plurality of the plurality of different geographic areas; identifying a given geographic area among the plurality of geographic areas in which the real property is located; and sending data indicative of the accuracy scores corresponding to the given geographic area to the remote computing device.
16. The method of embodiment 15, wherein sending data indicative of the accuracy scores comprises: ranking at least some of the plurality of realtors based on accuracy of estimates for other real properties; and sending data indicative of the ranking.
17. The method of any of embodiments 1-16, wherein: the real property is not listed as being for sale.
18. The method of any of embodiments 1-17, comprising: receiving a message from a user claiming to own the real property; after receiving the message, receiving an update on improvements to the property from the user claiming to own the property; and sending information about the updates to at least some estimators providing at least some of the plurality of estimates.
19. The method of any of embodiments 1-18, comprising: sending information about real property to users; and performing one or more of the following: sending advertisements to users selected based on past user interactions; obtaining subscriptions from realtors or other service providers; providing online services to realtors or other users; obtaining and selecting among bids to provide services requested by users; referring a user to a service provider and assessing a referral fee to a user account of the service provider; referring a user to a realtor and assessing a referral fee via a property sales contract; or a combination thereof.
20. The method of any of embodiments 1-19, comprising: obtaining indicators of interest in real properties in a plurality of geographic areas; obtaining demographic data on those expressing interest in the real properties; calculating geographic-area specific, demographic-specific interest scores based on the obtained indicators of interest and the obtained demographic data; and sending information about the interest scores to one or more users.
21. A tangible, non-transitory, machine-readable medium storing instructions that when executed by a data processing apparatus cause the data processing apparatus to perform operations comprising: the method of any of embodiments 1-20.
22. A system, comprising: one or more processors; and memory storing instructions that when executed by the processors cause the processors to effectuate operations comprising: the method of any of embodiments 1-20.

What is claimed is:

1. A method of crowdsourcing valuations of real property, the method comprising:
obtaining, with one or more processors, a plurality of estimates for a value of a real property from a plurality of users;
calculating, with one or more processors, an aggregate estimate for the real property based on the plurality of estimates;
receiving, with one or more processors, a request for the aggregate estimate from a remote computing device of a user; and
sending, with one or more processors, the aggregate estimate to the remote computing device for display to the user.

2. The method of claim 1, wherein at least some of the plurality of estimates are obtained from a plurality of realtors by performing steps comprising:
receiving realtor credentials from another computing device of a respective realtor among the plurality of realtors;
identifying a respective realtor user account based on the credentials;
sending information about the real property to the other computing device of the respective realtor;
receiving a respective estimate among the plurality of estimates from the other computing device of the respective realtor; and
after identifying the realtor user account, storing the estimate in association with a record of the real property and in association with the respective realtor user account.

3. The method of claim 2, comprising:
obtaining other estimates for a plurality of other real properties from a given realtor among the plurality of realtors;
obtaining sale prices for the plurality of other real properties;
calculating a plurality of estimation errors based on differences between the other estimates and the sale prices; and
calculating an accuracy score for the given realtor based on the plurality of estimation errors.

4. The method of claim 3, comprising:
identifying a plurality of realtors, including the given realtor, that provided an estimate for the value of the real property; and
sending the remote computing device of the user instructions to display the at least some of the plurality of realtors in ranked order based, at least in part, on the accuracy score of the given realtor relative to accuracy scores of at least some of other realtors among the plurality of realtors.

5. The method of claim 1, comprising:
after sending the aggregate estimate, receiving a request from the remote computing device for contact information for a given realtor that provided one of the estimates among the plurality of estimates;
sending the contact information to the remote computing device of the user; and
updating a realtor profile for the given realtor to reflect provision of a lead.

6. The method of claim 1, comprising:
sending, to the remote computing devices, at least some of the plurality of estimates and descriptions of reasons for the at least some of the sent estimates provided by estimators.

7. The method of claim 1, wherein calculating the aggregate estimate comprises:
calculating a measure of central tendency of the plurality of estimates.

8. The method of claim 1, wherein calculating the aggregate estimate comprises:
obtaining a respective accuracy score for estimators providing at least some of the plurality of estimates;
calculating the aggregate estimate based on both the accuracy scores and the plurality of estimates.

9. The method of claim 8, wherein calculating the aggregate estimate comprises:
filtering out estimates based on accuracy scores before calculating the aggregate estimate based on estimates that are not filtered out.

10. The method of claim 8, wherein calculating the aggregate estimate comprises:
calculated a weighted combination of the plurality of estimates.

11. The method of claim 10, wherein weights are based on accuracy scores such that lower accuracy scores tend to correlate with lower weights.

12. The method of claim 10, wherein weights are based on an age of the respective estimates of the plurality of estimates such that older estimates tend to correlate with lower weights.

13. The method of claim 10, comprising:
learning the weights with one or more processors by executing a gradient descent algorithm on a training set of historical estimates and sale prices.

14. The method of claim 1, comprising:
receiving a message to a real property owner from a realtor providing at least one of the plurality of estimates;
receiving a communication from the user of the remote computing device indicating that the user owns the real property;
determining that the real property is claimed by the user; and
in response to determining that the real property is claimed by the user, sending the message from the realtor to the real property owner.

15. The method of claim 1, comprising:
calculating accuracy scores for a plurality of realtors in a plurality of geographic areas, each realtor having a plurality of accuracy scores for each of at least a plurality of the plurality of different geographic areas;
identifying a given geographic area among the plurality of geographic areas in which the real property is located; and
sending data indicative of the accuracy scores corresponding to the given geographic area to the remote computing device.

16. The method of claim 15, wherein sending data indicative of the accuracy scores comprises:
ranking at least some of the plurality of realtors based on accuracy of estimates for other real properties; and
sending data indicative of the ranking.

17. The method of claim 1, wherein:
the real property is not listed as being for sale.

18. The method of claim 1, comprising:
receiving a message from a user claiming to own the real property;
after receiving the message, receiving an update on improvements to the property from the user claiming to own the property; and
sending information about the updates to at least some estimators providing at least some of the plurality of estimates.

19. The method of claim 1, comprising:
sending information about real property to users; and
performing one or more of the following:
sending advertisements to users selected based on past user interactions;
obtaining subscriptions from realtors or other service providers;
providing online services to realtors or users;
obtaining and selecting among bids to provide services requested by users;
referring a user to a service provider and assessing a referral fee to a user account of the service provider;
referring a user to a realtor and assessing a referral fee via a property sales contract; or
a combination thereof.

20. The method of claim 1, comprising:
obtaining indicators of interest in real properties in a plurality of geographic areas;
obtaining demographic data on those expressing interest in the real properties;
calculating geographic-area specific, demographic-specific interest scores based on the obtained indicators of interest and the obtained demographic data; and
sending information about the interest scores to one or more users.

21. A system, comprising:
one or more processors; and
memory storing instructions that when executed by at least some of the processors effectuate operations comprising:
obtaining a plurality of estimates for a value of a real property from a plurality of users;
calculating an aggregate estimate for the real property based on the plurality of estimates;
receiving a request for the aggregate estimate from a remote computing device of a user; and
sending the aggregate estimate to the remote computing device for display to the user.
